(19) United States
(12) Patent Application Publication
(10) Pub. No.: US 2018/0137792 A1
(43) Pub. Date: May 17, 2018

(54) SMOKING ARTICLE IDENTIFICATION SYSTEM AND METHOD

(71) Applicant: Angela L. Gransaull, Langton (CA)

(72) Inventor: Angela L. Gransaull, Langton (CA)

(21) Appl. No.: 15/353,369

(22) Filed: Nov. 16, 2016

(51) Int. Cl. G09F 23/00; A24D 3/04; B65D 77/22; B65D 85/671

(52) U.S. Cl. CPC G09F 23/00; B65D 85/671; B65D 77/22; A24D 3/04

(57) ABSTRACT

A smoking article identification system and method is disclosed herein. The smoking article identification system includes a smoking article identification system comprising a cigarette filter tip including a tubular member insertable within one end of a hand rolled cigarette. The tubular member includes a first end, a second end, at least one smoke-conducting passage configured to pass smoke, produced by combustion of smokable substances of the hand rolled cigarette, between the first end and the second end, and a visual indicator usable to indicate at least one characteristic of the hand rolled cigarette. In addition, a package configured to hold a plurality of the cigarette filter tips is provided. The smoking article identification system is useful for hand-rolled smoking article identification.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of cigarette filter making art and more specifically relates to attaching filters to cigarettes, e.g., inserting filters into cigarettes

### 2. Description of Related Art

Decades of scientific research has revealed many potential benefits of cannabis and cannabinoids compounds in the treatment of medical conditions. Many jurisdictions now allow the use of medicinal cannabis by persons with debilitating medical conditions, such as chronic pain, glaucoma, nausea, inflammation, seizures, etc. Hundreds of medicinal cannabis strains are now available for use by individuals seeking safe and effective medical therapies.

Among the variety of ways medicinal cannabis is consumed, smoking and oral consumption are the most common methods. Those that choose to consume medicinal cannabis by smoking may utilize various delivery techniques, including inhalation of smoke released by burning selected portions of the plant in a cigarette-like “joint” or cigar-like “blunt”.

Many individuals choose to hand roll their own marijuana cigarettes using rolling paper and related paraphernalia. As a matter of convenience, an individual may pre-roll multiple marijuana cigarettes for later consumption. A problem arises when an individual pre-rolls several marijuana cigarettes containing differing varieties of medicinal cannabis. The inherent visual uniformity of such smoking articles can result in confusion as to which joint or blunt contains a particular medicinal cannabis strain. This can lead to an incorrect or delayed treatment. In light of the above, it is clear that technological advancements in apparatus and methods to assist the identification of such smoking articles would benefit many.

The known prior art in this field fails to solve the above-mentioned problem. For example, U.S. Pat. No. 9,179,706 to Jespersen et al. relates to filter tip, tubes, and cones. In the described patent to Jespersen et al. a filter strip is provided for rolling sheets to construct custom cigars and/or cigarettes. The filter strip may be made of a deformable material which can be positioned on one end of the rolling sheet. The filter strip can be folded in a zig zag or spiral filter section with open section located longitudinally below to form a filter tip. The filter tip can assist the user in rolling by hand a substantially cylindrical or conical cigar or cigarette. The filter tip prevents tobacco filler material from being drawn through the cigar or cigarette and into a user's mouth, and permits the entire amount of tobacco filler to be consumed/smoked without risking burned hands and/or lips.

### BRIEF SUMMARY OF THE INVENTION

In view of the foregoing disadvantages inherent in the known cigarette filter making art, the present disclosure provides a novel smoking article identification system and method. The general purpose of the present disclosure, which will be described subsequently in greater detail, is to provide a smoking article identification and method.

A smoking article identification system and method is disclosed herein. The smoking article identification system and method includes a cigarette filter tip including a tubular member insertable within one end of a hand rolled cigarette. The tubular member has a first end, a second end, at least one smoke-conducting passage. The smoke-conducting passage is configured to pass smoke, produced by combustion of smokable substances of the hand rolled cigarette, between the first end and the second end. In addition, the tubular member includes a visual indicator usable to indicate at least one characteristic of the hand rolled cigarette. A package configured to hold a plurality of the cigarette filter tips is also provided.

In one embodiment of the system, the visual indicator is a color. In another embodiment of the system, the visual indicator may be at least two differing colors. In yet another embodiment of the system, the visual indicator may include a geometric pattern. Additional, embodiments of the system may include a plurality of the cigarette filter tips held within the package, wherein at least two of the cigarette filter tips of the plurality contain differing visual indicators.

Moreover, in at least one embodiment of the system, the tubular member may be constructed from a paper material. In another embodiment of the system, the paper material may be integrally colored. In an additional embodiment of the system, the visual indicator may consist of indicia, including words, imprinted on the paper material. Even further, the tubular member may include an outer surface with at least one portion of the outer surface having an adhesive configured to assist a user assemble the hand rolled cigarette.

In addition, it provides such a smoking article identification system wherein the tubular member may be substantially cylindrical. In one embodiment of the system, the tubular member may be formed from a single sheet of the paper material. The paper material forming the tubular member includes a coiled center section. In additional embodiments of the system the tubular members may be formed from multiple sheets of the paper material. In one embodiment of the system, at least two of the multiple sheets of the paper material may include differing visual indicators.

Even further, the package of the smoking article identification system may be a flexible bag. In another embodiment of the system, the package may be a rigid paper box. In addition, the system may include a set of instructions; and wherein the smoking article identification system is arranged as a kit.

According to another embodiment, a smoking article identification method is also disclosed herein. The smoking article identification method includes the steps of: providing a plurality of cigarette filter tips, each one including a tubular member insertable within one end of a hand rolled cigarette, the tubular member having a first end, a second end, at least one smoke-conducting passage configured to pass smoke, produced by combustion of smokable substances of the hand rolled cigarette, between the first end and the second end. The tubular member further includes a visual indicator usable to indicate at least one characteristic of the hand rolled cigarette.

The method further includes the step of selecting from the plurality of cigarette filter tips, a group of cigarette filter tips including at least two cigarette filter tips each having differing visual indicators providing packaging configured to hold the selected group of cigarette filter tips; and the step of installing the selected group of cigarette filter tips within the packaging. Even further, the method includes the providing a set of instructions, the set of instructions including use of the visual indicators to identify at least one characteristic of a hand rolled cigarette containing one of the cigarette filter tips of the selected group.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a smoking article identification system and method, constructed and operative according to the teachings of the present disclosure.

FIG. 1 is a perspective view of a smoking article identification system during an ‘in-use’ condition, according to an embodiment of the disclosure.

FIG. 2 is a perspective view of an identifying filter tip of the smoking article identification system of FIG. 1, according to an embodiment of the present disclosure.

FIG. 3 is a perspective view of another identifying filter tip of the smoking article identification system of FIG. 1, according to an embodiment of the present disclosure.

FIG. 4 is a perspective view of another identifying filter tip of the smoking article identification system of FIG. 1, according to an embodiment of the present disclosure.

FIG. 5 is a perspective view of another identifying filter tip of the smoking article identification system of FIG. 1, according to an embodiment of the present disclosure.

FIG. 6 is a perspective diagram showing the structures and arrangements of an identifying filter tip of the smoking article identification system of FIG. 1, according to one embodiment of the present disclosure.

FIG. 7 is a sectional view through the section 7-7 of FIG. 6 showing the internal arrangements of embodiment of FIG. 6.

FIG. 8 is a perspective view showing a plurality of identifying filter tips located within a flexible package, according to one embodiment of the present disclosure.

FIG. 9 is a perspective view showing a plurality of identifying filter tips located within a rigid package, according to another embodiment of the present disclosure.

FIG. 10 is a perspective view showing a plurality of identifying filter tips located within a larger rigid package, according to another embodiment of the present disclosure.

FIG. 11 is a flow diagram illustrating a smoking article identification method, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to cigarette filter making art and more particularly to a prefabricated smoking article identification system and method as used to improve the smoking article identification.

Generally, the present disclosure describes a smoking article identification system using prefabricated “Canadian” filter tips for marijuana (cannabis) cigarettes. The system is useful for individuals who cannot roll the filters themselves, who don't have the time or ability (e.g., due to sickness or disease), or who simply prefer not to roll the filters for their marijuana cigarettes themselves.

The prefabricated smoking article identification system will assist people who have to medicate with medicinal marijuana. Some of these individuals do not have the hand/finger dexterity, ability, time, inclination, or are too sick to roll filter tips for their everyday use. Many individuals engage in therapies that require them to smoke medicinal marijuana repeatedly every single day. Often, these individuals must fabricate the filter tips themselves out of whatever paper product they have at their disposal. The present system will enable these individuals to simply pick one or two preformed filter tips out of a package and use them to easily and quickly roll or even pre-roll a selected number of marijuana cigarettes, making the disclosed embodiments of the present system not only cost-effective, but most importantly a convenient tool that eases the task of repeatedly having to prepare to self medicate, it is also user friendly, and time efficient as well.

The color-coding of the filter tips is a very important aspect of the present system; it allows medical marijuana users to clearly identify the characteristics of their rolled or pre-rolled marijuana cigarette, and even more so when multiple pre-rolled marijuana cigarettes are prepared for later use. There are many different strains of medicinal marijuana for various medicinal purposes, all with specific and varying health benefits. This system will allow the user to prepare the cigarettes with the different color-coding and therefore differentiate the pre-rolled medication according to use and health benefit. This will cut down the preparation time, increase the accuracy of treatment, and reduce some of the burden for every person that has to roll marijuana joints or blunts.

Using the filter tips allow the end user to access more of the medication/herb that they are medicating with. Without a filter, the user frequently ends up with a small amount of material that is not accessible, due to the heat and/or moisture that builds up at the mouth-engaging portion of the joint or blunt. The filter tip allows for more complete burning of the medication/herb, a more even flow of smoke, and improved distribution of suction across the sectional profile. This reduces waste when consuming the medication/herb by smoking and therefore saves the end user money.

Preferred features of the disclosed system may include:
pre-rolled filter tips requiring no work by the end-user,
color coding of the filter tips to allow medicinal marijuana users to clearly identify characteristics of pre-rolled marijuana cigarettes,
an ability to adapt to all sizes of marijuana cigarettes (i.e., both joints and bunts),
having a low cost, and
providing a product that is both functional and visually appealing for users.

Embodiments of the present system may include different lengths, colors, paper weight, packaging etc., as will be described in greater detail below. In the following descriptions, the terms “joint” and “blunt” may be used interchangeably with the term marijuana cigarette.

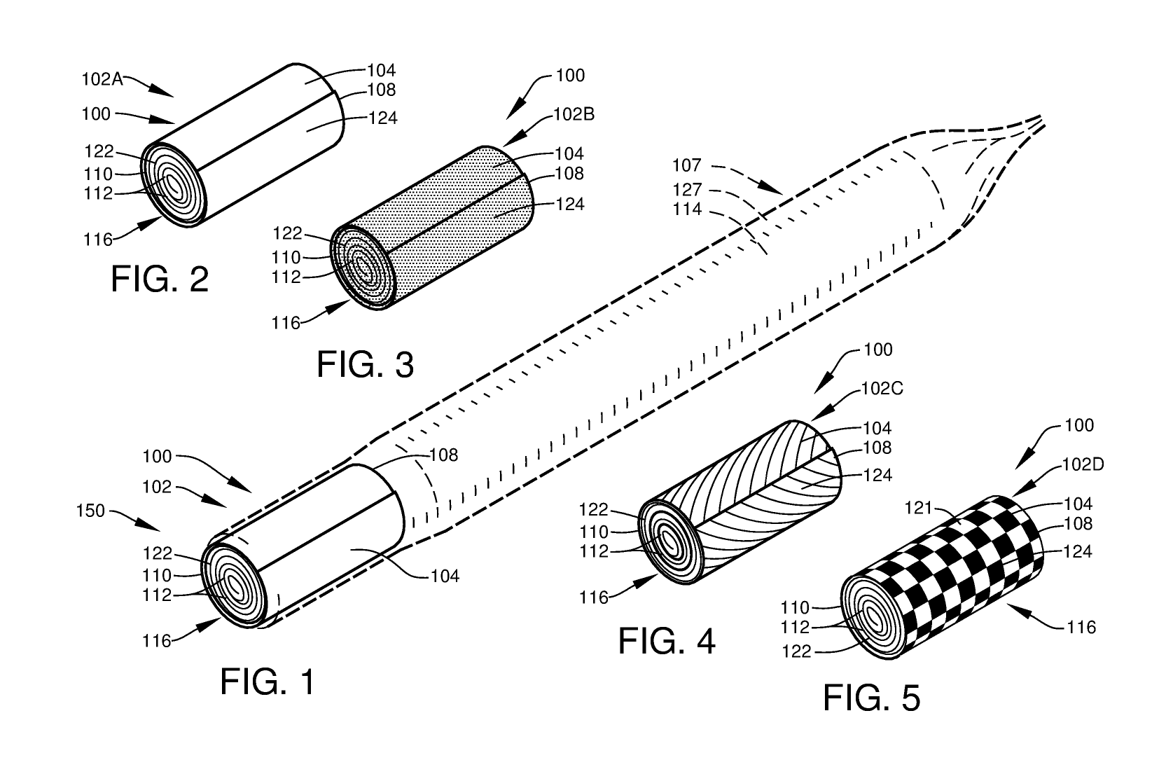

Referring now more specifically to the drawings by numerals of reference, there is shown in FIGS. 1-11, various views of a smoking article identification system 100. FIG. 1 shows an embodiment of the smoking article identification system 100 during an ‘in-use’ condition 150, according to an embodiment of the present disclosure. Here, the smoking article identification system 100 may be beneficial for use by a user to provide a pre-formed and ready to use filter tip 102 having one or more identifying features. As illustrated, the smoking article identification system 100 may include a pre-formed cigarette filter tip 102 having a tubular member 104 that may be inserted within one end of a hand rolled cigarette 107. The tubular member 104 has a first end 108, a second end 110, and at least one internal smoke-conducting passage 112 that extends between the first end 108 and the second end 110. The smoke-conducting passage 112 is configured to pass smoke produced by combustion of the smokable substances 114, between the first and second ends.

FIG. 2 is a perspective view of an identifying filter tip 102A of the smoking article identification system 100. The pre-formed tubular member 104 of the identifying filter tip 102A may include one or more visual indicators 116 usable to indicate at least one characteristic of the hand rolled cigarette 107, such as, for example, the particular strain of medicinal marijuana contained within the hand rolled cigarette 107. Visual indicators 116 applied to the filter tip embodiments of the present disclosure may include, but are not limited to colors, patterns, words, or combinations thereof. A person may use the visual indicators 116 to identify a particular characteristic of a hand rolled marijuana cigarette 107. This is accomplished by incorporating the filter tip, having a particular visual indicator 116, within a marijuana cigarette 107 containing a distinguishing characteristic, such as, for example, a particular medicinal marijuana strain (see also FIG. 1). By associating the selected visual indicator 116 with a specific characteristic of the smoking article, a user can quickly and easily identify the marijuana cigarettes 107 having the associated characteristic within a group of pre-rolled marijuana cigarettes 107. This feature is of great benefit in eliminating confusion when multiple marijuana cigarettes 107 containing differing varieties of medicinal cannabis are prepared for later use.

FIG. 3 is a perspective view of another identifying filter tip 102B of the smoking article identification system 100. The physical size and shape of this alternate identifying filter tip 102B may be substantially the same as the embodiment depicted in FIG. 2; however, the visual indicator 116 applied to the alternate identifying filter tip 102B of FIG. 3 includes a color that is visibly different from the color of the visual indicator 116 applied to the identifying filter tip 102A of FIG. 2. The alternate identifying filter tip 102B of FIG. 3 may be supplied in a wide range of colors, thus allowing the user to selectively identify the contents and characteristics of many different marijuana cigarettes 107.

FIG. 4 is a perspective view of another identifying filter tip 102C of the smoking article identification system 100. The visual indicator 116 of the identifying filter tip 102C includes at least two distinct colors. In this example, the material forming the internal smoke-conducting passage 112 has a color that is visually different from the color of the material forming the substantially cylindrical outer wall 124, as shown.

FIG. 5 is a perspective view of another identifying filter tip 102D of the smoking article identification system 100, according to yet another embodiment of the present disclosure. The visual indicator 116 of the depicted embodiment of FIG. 5 includes a geometric pattern 121. Although a checker-board pattern is shown, many alternate patterns are envisioned, which may include but are not limited to dot patterns, color banding, repeated shapes, random patterns, etc. Upon reading this specification, it should be appreciated that, under appropriate circumstances, considering such issues as user preferences, design preference, marketing preferences, cost, available materials, available printing techniques, etc., the use of other visual indicators such as, for example, differing surface textures, printed text, photographic depictions, thermochromic (color changing) inks, UV visible inks, symbols, character depictions, corporate branding, team logos, flavored inks, etc., may be sufficient.

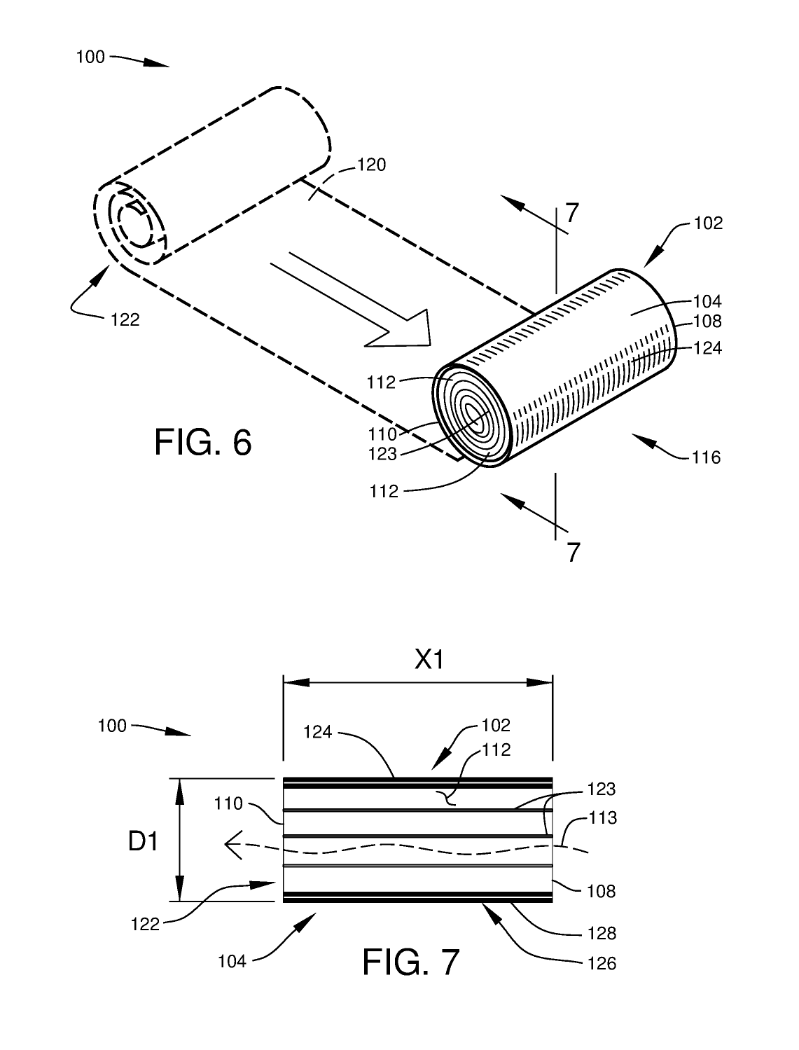

FIG. 6 is a perspective diagram showing the structures and arrangements of a representative identifying filter tip 102 of the smoking article identification system of FIG. 1, according to one embodiment of the present disclosure. Embodiments of the system include tubular members 104 constructed from a paper material 120. The paper material 120 forming the tubular members 104 may range in weight from between about 132 grams per square meter (about 32 pounds U.S. basis weight) and about 180 grams per square meter (about 67 pounds U.S. basis weight). The paper material 120 forming the tubular member 104 contains a rolled coiled center section 122 disposed within a substantially cylindrical outer wall 124. The rolled coiled center sections 122 may form a set of arcuate internal ribs 123 defining the smoke-conducting passages 112 (see also FIG. 7).

The tubular member 104 is pre-rolled to form a substantially cylindrical shape, as shown. Upon reading this specification, it should be appreciated that, under appropriate circumstances, considering such issues as user preferences, design preference, structural requirements, marketing preferences, cost, available materials, etc., other shape arrangements such as, for example, oval, square, polygonal, etc., may be sufficient.

In one embodiment of the system, the tubular member 104 is formed from a single sheet of the paper material 120, as indicated by the dashed-line depiction of FIG. 6. In additional embodiments of the system, the tubular members 104 may be formed from multiple sheets of the paper material 120. In the embodiment of FIG. 4, at least two of the multiple sheets of the paper material 120 forming the internal ribs of the filter tip are of differing colors.

The visual indicator 116 of the depicted embodiments may be implemented using a number of techniques. In one embodiment of the system, the paper material is integrally colored using an ink, a dye, or a naturally-colored material. In general, the selected materials are both colorfast and non-toxic. In another embodiment of the system, the visual indicator may consist of indicia imprinted on the paper material using an ink or dye and one or more printing processes. Printing processes suitable for use in the present system include conventional planographic printing, offset printing, gravure printing, flexographic printing, dye sublimation printing, inkjet printing, laser printing, transfer printing, etc. In general, the ink and dyes used in the printing processes are both colorfast and non-toxic.

FIG. 7 is a sectional view through the section 7-7 of FIG. 6 showing the internal arrangements of embodiment of FIG. 6. Visible in FIG. 7 is the first end 108, the second end 110, and the smoke-conducting passages 112 of tubular member 104. The tubular member 104 may include different lengths X1 and diameters D1. The length X1 of tubular member 104 is at least sufficient to provide a stable contact with the rolling paper 127 (see FIG. 1), for example, the length X1 may at least equal the diameter D1.

A user may also combine two tubular members 104 into one to produce a larger device. For example, the end user may combine three to five tubular members 104, as required to suite their need. The pre-rolled construction of the tubular members 104 allows the user to unroll the device and fit one into another until the required size is achieved.

Alternately, one tubular member 104 can be rolled small enough to fit a smaller joint, if needed or into another filter if required to make a larger filter. To achieve a smaller diameter D1, the end user rolls the tubular member 104 between their index finger and thumb and applies a small amount of pressure, which results in the tubular member 104 forming the smaller outer diameter. A user may also cut or tear off a small piece of an end of the tubular member 104 to form a version of the device having a shorter length X1, in turn forming a smaller outer diameter.

Each smoke-conducting passage 112 is configured to enable the passage of smoke 113, produced by combustion of the smokable substances contained within the hand rolled cigarette 107 (see FIG. 1), between the first end 108 and the second end 110. The filter tip 102 allows for more complete burning of the medicinal cannabis material, a more even flow of smoke 113, and improved distribution of suction across the sectional profile of the tubular member 104.

In some embodiments of the present system, the tubular member 104 includes an outer surface 126 with at least one portion of the outer surface 126 having an applied, non-toxic adhesive 128 configured to assist a user assemble the hand rolled cigarette. Upon reading this specification, it should be appreciated that, under appropriate circumstances, considering such issues as user preferences, design preference, structural requirements, marketing preferences, cost, available materials, technological advances, etc., other filter tip constructions such as, for example, filters formed from plastic, glass, ceramic, composites, etc., may be sufficient.

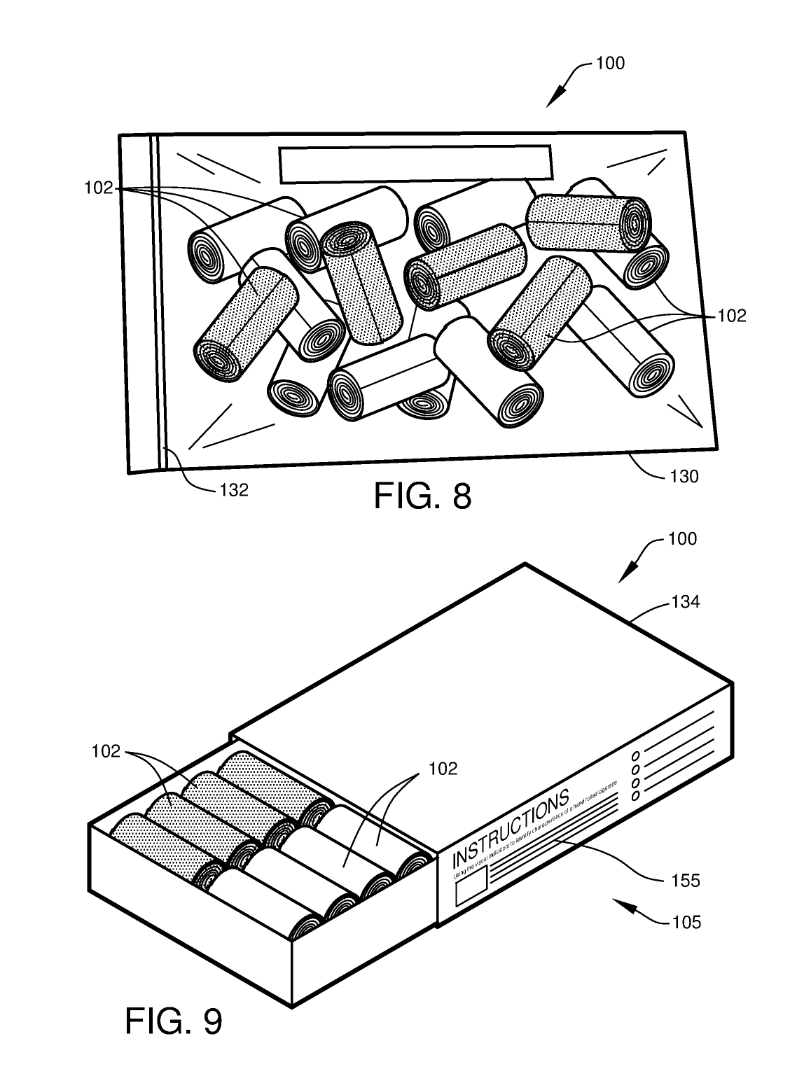

A package configured to hold a plurality of the cigarette filter tips 102 may also be provided. In this arrangement, groupings of cigarette filter tips 102 may be packaged together, as shown in FIG. 8 and FIG. 9. At least two of the cigarette filter tips 102 of a selected group may contain differing visual indicators 116 (i.e., colors, patterns, etc.).

FIG. 8 is a perspective view showing a plurality of identifying filter tips 102 located within a flexible package 130, according to one embodiment of the present disclosure. The flexible package 130 may be a transparent, translucent, or opaque plastic bag or similar flexible container. The flexible package 130 may contain a re-sealable feature 132 of a type well known in the art. In this arrangement, at least two of the cigarette filter tips 102 of the plurality contain differing visual indicators 116, as shown.

FIG. 9 is a perspective view showing a plurality of identifying filter tips 102 located within a rigid package 134, according to another embodiment of the present disclosure. The rigid portion of the carton may be formed of paperboard or thin cardboard assembled in the configuration shown. As previously noted, at least two of the cigarette filter tips 102 included in the package contain differing visual indicators 116, as shown.

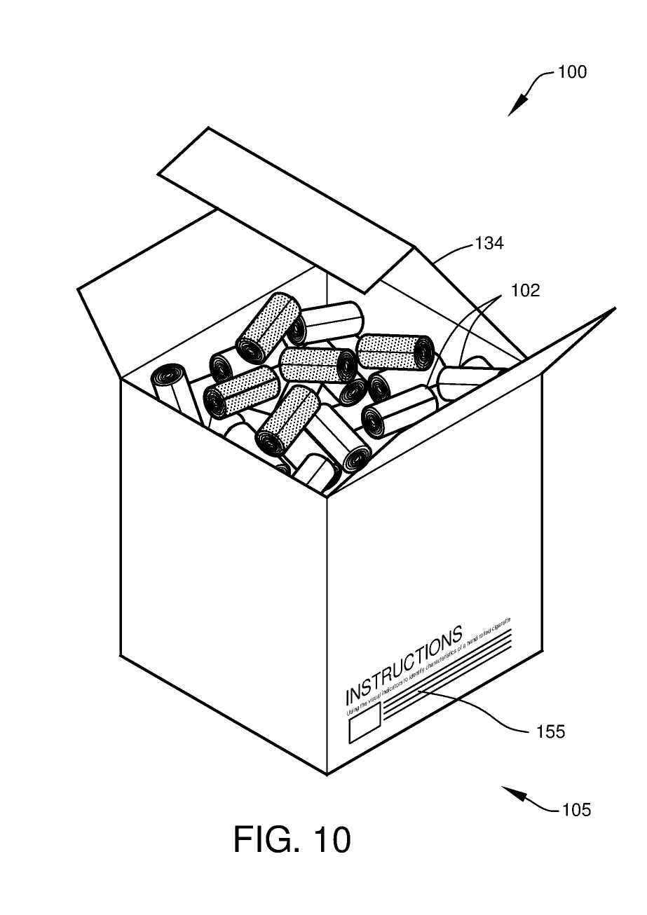

In another embodiment, the rigid package 134 may have a larger capacity, for example, the rigid package 134 may be a three inch square container capable holding 100 or 200 cigarette filter tips 102, as shown in FIG. 10. As previously noted, at least two of the cigarette filter tips 102 included in the package contain differing visual indicators 116, as shown.

According to one embodiment, the smoking article identification system 100 may be arranged as a kit 105. In particular, the smoking article identification system 100 may further include a set of instructions 155. The instructions 155 may detail functional relationships in relation to the structure of the smoking article identification system 100 (such that the smoking article identification system 100 can be used, maintained, or the like, in a preferred manner). More specifically, the set of instructions 155 may describe how a visual reminder system using the colors or patterns of the filter tips 102 may be implemented by a user.

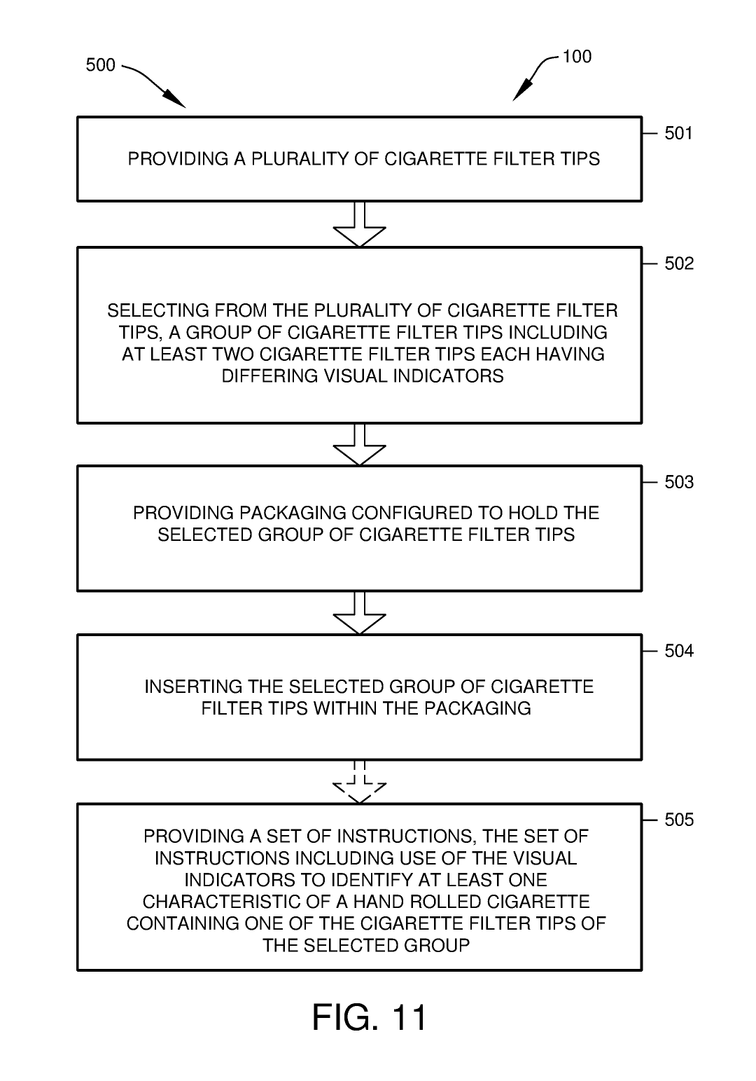

FIG. 11 is a flow diagram illustrating a smoking article identification method, according to an embodiment of the present disclosure. In particular, the smoking article identification method 500 may include one or more components or features of the smoking article identification system 100 as described above. As illustrated, the smoking article identification method 500 may include the steps of: step one 501, providing a plurality of cigarette filter tips, each one including a tubular member insertable within one end of a hand rolled cigarette, the tubular member having a first end, a second end, at least one smoke-conducting passage configured to pass smoke, produced by combustion of smokable substances of the hand rolled cigarette, between the first end and the second end. The tubular member further includes a visual indicator usable to indicate at least one characteristic of the hand rolled cigarette; step two 502, selecting from the plurality of cigarette filter tips, a group of cigarette filter tips including at least two cigarette filter tips each having differing visual indicators; step three 503, providing packaging configured to hold the selected group of cigarette filter tips; and step four 504, inserting the selected group of cigarette filter tips within the packaging.

Even further, the method includes step five 505, providing a set of instructions, the set of instructions including use of the visual indicators to identify at least one characteristic of a hand rolled cigarette containing one of the cigarette filter tips of the selected group.

It should be noted that step 505 is an optional step and may not be implemented in all cases. Optional steps of method of use 500 are illustrated using dotted lines in FIG. 5 so as to distinguish them from the other steps of method of use 500. It should also be noted that the steps described in the method of use 500 can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for identification of smoking articles (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A smoking article identification system comprising:
a pre-formed cigarette filter tip including a tubular member insertable within one end of a hand rolled cigarette, the tubular member having
a first end,
a second end,
at least one smoke-conducting passage configured to pass smoke, produced by combustion of smokable substances of the hand rolled cigarette, between the first end and the second end, and
a visual indicator usable to indicate at least one characteristic of the hand rolled cigarette; and
a package configured to hold a plurality of the cigarette filter tips.

2. The smoking article identification system of claim 1, wherein the visual indicator is a color.

3. The smoking article identification system of claim 1, wherein the visual indicator comprises at least two differing colors.

4. The smoking article identification system of claim 1, wherein the visual indicator comprises a geometric pattern.

5. The smoking article identification system of claim 1, further comprising the plurality of the cigarette filter tips held within the package, wherein at least two of the cigarette filter tips of the plurality comprise differing visual indicators.

6. The smoking article identification system of claim 1, wherein the tubular member is constructed from a paper material.

7. The smoking article identification system of claim 1, wherein the paper material is integrally colored.

8. The smoking article identification system of claim 1, wherein the visual indicator comprises indicia imprinted on the paper material.

9. The smoking article identification system of claim 1, wherein the tubular member is substantially cylindrical.

10. The smoking article identification system of claim 1, wherein the tubular member is formed from a single sheet of the paper material.

11. The smoking article identification system of claim 1, wherein the paper material forming the tubular member is comprised entirely of a rolled coiled center section.

12. The smoking article identification system of claim 1, wherein the tubular member is formed from multiple sheets of the paper material.

13. The smoking article identification system of claim 1, wherein at least two of the multiple sheets of the paper material comprise differing visual indicators.

14. The smoking article identification system of claim 1, wherein the tubular member comprises an outer surface and at least one portion of the outer surface comprises an adhesive configured to assist a user assemble the hand rolled cigarette.

15. The smoking article identification system of claim 1, wherein the package comprises a flexible bag.

16. The smoking article identification system of claim 1, wherein the package comprises a rigid paper box.

17. A smoking article identification system, comprising:
a pre-formed cigarette filter tip including a tubular member insertable within one end of a hand rolled cigarette, the tubular member having
a first end,
a second end,
at least one smoke-conducting passage configured to pass smoke, produced by combustion of smokable substances of the hand rolled cigarette, between the first end and the second end, and
a visual indicator usable to indicate at least one characteristic of the hand rolled cigarette; and
a package configured to hold a plurality of the cigarette filter tips;
wherein the visual indicator comprises at least one color;
wherein the plurality of the cigarette filter tips held within the package comprises at least two differing visual indicators;
wherein the tubular member is constructed from a paper material;
wherein the tubular member is substantially cylindrical; and
wherein the paper material forming the tubular member is comprised entirely of a rolled coiled center section.

18. The smoking article identification system of claim 17, further comprising set of instructions; and wherein the smoking article identification system is arranged as a kit.

19. A smoking article identification method, the method comprising the steps of:
providing a plurality of pre-formed cigarette filter tips, each one including a tubular member insertable within one end of a hand rolled cigarette, the tubular member having
a first end,
a second end,
at least one smoke-conducting passage configured to pass smoke, produced by combustion of smokable substances of the hand rolled cigarette, between the first end and the second end, and
a visual indicator usable to indicate at least one characteristic of the hand rolled cigarette;
selecting from the plurality of cigarette filter tips, a group of cigarette filter tips including at least two cigarette filter tips each having differing visual indicators;
providing packaging configured to hold the selected group of cigarette filter tips; and
inserting the selected group of cigarette filter tips within the packaging.

20. The method of claim 19, further comprising the step of:
providing a set of instructions, the set of instructions including use of the visual indicators to identify at least one characteristic of a hand rolled cigarette containing one of the cigarette filter tips of the selected group.
